(19) United States
(12) Patent Application Publication
(10) Pub. No.: US 2005/0008143 A1
(43) Pub. Date: Jan. 13, 2005

(54) Echo canceller having spectral echo tail estimator

(76) Inventors: Mathias Lang, Eindhoven (NL); Cornelis Pieter Janse, Eindhoven (NL)

Correspondence Address: Philips Corporation;Intellectual Property Department, P O Box 3001, Briarcliff Manor, NY, 10510, US

(21) Appl. No.: 10/498,295

(22) PCT Filed: Dec. 9, 2002
(86) PCT No.: PCT/IB02/05263

(30) Foreign Application Priority Data
Dec. 14, 2001 (EP) 01204906.0

(51) Int. Cl. H04M 9/08

(52) U.S. Cl. 379/406.1

(57) ABSTRACT

An echo canceller comprises a signal input for a far end signal, an audio input for a distorted desired signal, an echo estimator coupled to the signal input, and a spectral subtracter coupled to the echo estimator and the audio input. The echo estimator further comprises digital filter means covering a time span of at least a part of the echo to be cancelled. Spectral subtraction of the echo part does not make use of echo phase information. Consequently this saves memory and processing power of calculations made in the echo canceller. Futhermore these calculations are not restricted to a particular decaying course of the room impulse response, as any kind of echo tail course may be modelled. This provides a larger degree of freedom in practical embodiments and broadens the application area of the echo canceller.

The present invention relates to an echo canceller, comprising a signal input for a far end signal, an audio input for a distorted desired signal, an echo estimator coupled to the signal input, and a spectral subtracter coupled to the echo estimator and the audio input.

The present invention also relates to a system, in particular a communication system, for example a hands-free communication device, such as a telephone, or a voice control system, which system is provided with such an echo canceller, and relates to a method for cancelling an acoustic echo by spectral filtering.

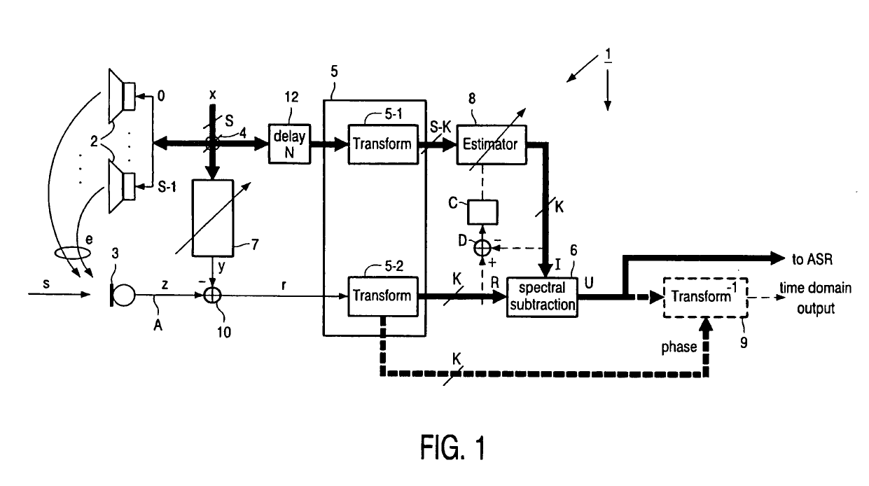

Such an echo canceller embodied by an arrangement for suppressing an interfering component, such as an echo, is known from WO 97/45995. The known echo canceller comprises a signal input carrying a far end signal, and a subtracter audio input for an desired microphone signal which is distorted by the echo. The echo canceller also comprises an echo spectrum estimator, which in one conceivable embodiment indicated by a dotted line in FIG. 1 is coupled to the signal input, and comprises a spectral subtracter embodied by a spectral filter coupled to the echo estimator and the audio input. The signal input is also coupled to an adaptive filter for deriving a replica of the echo signal from the far end echo signal. In a subtracter the replica is subtracted from the echo distorted audio signal, in order to eliminate the undesired echo signal. The spectral filter has a transfer function whose setting is dependent on the determined echo spectrum estimate, in order to improve the echo cancellation further by reproducing an estimate of a residual—also called tail or diffuse—part of the undesired echo signal. With respect to this tail part it is assumed that this part is associated with a necessarily exponential decaying envelope of the room impulse response. However this assumption implies a restriction, which under certain practical and possibly changing conditions may not always lead to accurate echo tail cancelling. This holds all the more for the conceivable embodiment mentioned above. Furthermore this restriction limits the application possibilities of known echo cancellers, especially if used in combination with automatic speech recognition where a high attenuation of acoustic echoes is very important.

In addition in case of another known embodiment, wherein the echo spectrum estimator is coupled to an output of the adaptive filter an interdependence arises between a possible slow response of the adaptive filter and the thus delayed input to the echo estimator and between possible errors occurring in the adaptive filter and a proper operation of the spectral subtracting filter. This interdependence has a negative effect on the robustness of the echo cancelling, in particular for non stationary signals, and may lead to poor practical echo cancelling results.

Therefore it is an object of the present invention to provide an echo canceller posing less restrictions on the echo tail behavior it is capable to cancel, and to provide an echo canceller which provides a broader practical application area in a robust way.

Thereto the echo canceller according to the invention is characterized in that the echo estimator comprises digital filter means covering a time span of at least a part of the echo to be cancelled.

Similarly the method according to the invention is characterized in that at least a part of the echo is being estimated digitally and then spectrally filtered.

It is an advantage of the echo canceller according to the present invention that the echo estimator calculates at least a tail part of the echo. Echo tail part compensation then takes place by means of spectral filtering. The necessary calculations are however not restricted to a particular decaying course of the room impulse response, such as the exponential decaying course, as any kind of echo tail course may be modelled now. This provides a larger degree of freedom in practical embodiments and broadens the application area of the present echo canceller. Furthermore, either a FIR or an IER digital filter implementation may be used. In addition the digital filter means may be chosen to cover the time span of the whole or a tail part of the echo.

The echo tail part is not cancelled based on information provided by an adaptive filter, if at all present. This increases the reliability and accuracy of the echo canceller according to the invention. In addition the echo tail estimator operates independently, in particular from the adaptive filter, which may be present in the echo canceller according to the invention. Therefore any non ideal behavior of such an adaptive filter is not reflected in the quality of the echo, in particular the echo tail calculations. This leads to an improved robustness of at least the echo tail cancellation by the echo canceller according to the invention.

The echo tail estimator provides spectral magnitude or spectral power echo tail data to the spectral subtractor and thus does not make use of echo phase information. Consequently this saves memory and processing power of calculations made in the echo canceller according to the invention.

An embodiment of the echo canceller according to the invention is characterized in that the echo tail estimator comprises a number of digital filters, which number is equal to the number of echo paths in the echo canceller.

For every echo path between one or more loudspeakers and one or more microphones present in the echo canceller this embodiment has one digital filter having appropriate respective sample lengths.

A simplified embodiment of the echo canceller according to the invention is characterized in that the echo estimator comprises one digital filter.

In this simple embodiment the echo signals are accumulated per spectral frequency bin and then fed to the one digital filter, which computes the estimated echo. In cases where all tail parts of the echo or echoes originate from a same room the tail parts of the room impulse responses mainly differ mutually in their respective phases—which are neglected by the spectral estimator—but not so much in their spectral magnitudes. Consequently, the error introduced by replacing the filters by one digital filter is relatively small, while this considerably reduces the implementation cost of the echo canceller according to the invention.

A preferred embodiment of the echo canceller according to the invention is characterized in that the echo canceller comprises an adaptive filter coupled to the signal input for estimating the pre-tail part of the echo signal.

In this embodiment the full echo, including the pre-tail part and the tail part are effectively cancelled by the adaptive filter and the echo tail estimator independently. In addition the individual lengths of the echo parts of the impulse responses to be compensated may be chosen, such that for example the adaptive filter is relatively short.

Preferably the echo canceller according to the invention is further characterized in that the echo estimator is arranged as an adaptive echo estimator.

Advantageously the echo tail calculations are capable of adapting to changes in the room impulse response, which may for example be due to movements in the room.

Divided spectral transformation means may be present in another embodiment of the echo canceller according to the invention which is characterized in that the echo canceller comprises a parallel arrangement of first and second spectral transformation means.

In an embodiment, which is particularly suited for application in an Automatic Speech Recognition (ASR) system, the echo canceller according to the invention is characterized in that the spectral transformation means comprises at least one filter bank.

If no time domain output is required in the ASR system a filter bank can be used to reduce the frequency resolution and thereby reducing the implementation costs of the echo canceller according to the invention.

Still another embodiment of the echo canceller according to the invention suited for a communication system, for example a hands-free communication device, such as a mobile telephone, is characterized in that the echo canceller comprises inverse spectral transformation means.

At present the echo canceller and associated echo cancelling method according to the invention will be elucidated further together with its additional advantages while reference is being made to the appended drawing, wherein similar components are being referred to by means of the same reference numerals.

In the drawings:

FIG. 1 shows a schematic overall view incorporating several possible embodiments of the echo canceller according to the invention;

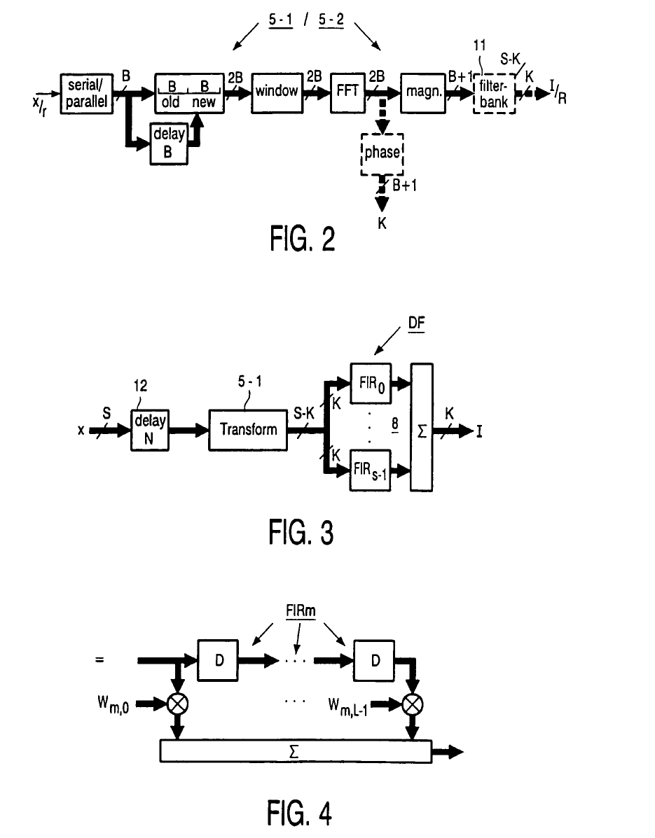

FIG. 2 shows a schematic view of transformation means for application in the echo canceller of FIG. 1;

FIG. 3 details the estimator for application in the echo canceller of FIG. 1;

FIG. 4 shows a FIR filter arrangement for application in the estimator of FIG. 3;

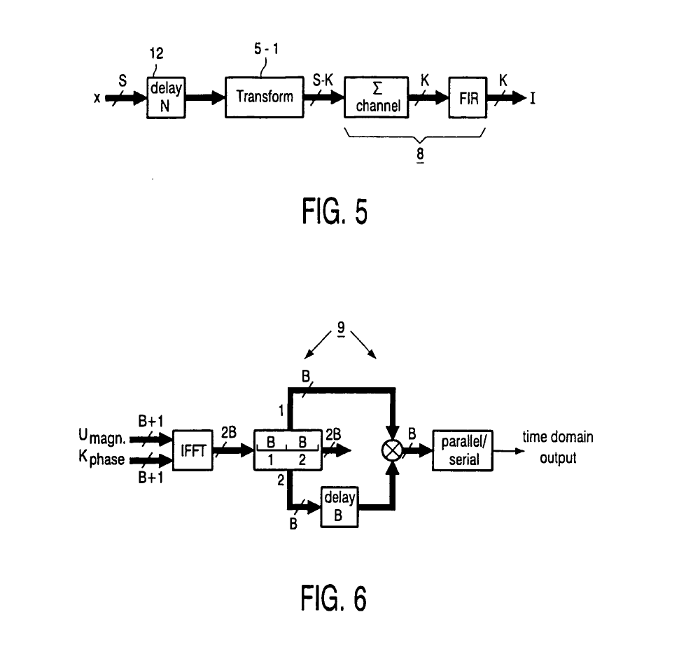

FIG. 5 shows a simplified arrangement of the estimator of FIG. 3; and

FIG. 6 shows a schematic view of inverse transformation means for application in the echo canceller of FIG. 1.

FIG. 1 shows an echo canceller 1 coupled to one or more loudspeakers 2 and possibly one or more microphones, one thereof namely the microphone 3 being shown for simplicity reasons. Between a number of S loudspeaker 2 and microphone 3 there are echo paths, collectively designated e. The microphone 3 receives a wanted signal s and the collected echo signal e resulting in a microphone signal z on an audio input A. The echo canceller 1 comprises a signal input 4 carrying signals including S far end signals x. The echo canceller 1 also comprises spectral transformation means 5 coupled to the signal input 4 and the audio input A, and comprises a spectral subtracter 6 possibly also to be seen as a spectral filter, coupled to the means 5. The spectral means 5 calculate in first spectral transformation means 5-1, the spectral components of the far end signal on input 4. A first or hereinafter called pre-tail part of the echo e is modelled by an adaptive filter 7 which may be included in the echo canceller 1, but this is not necessary, though preferred in practice.

In most practical applications this adaptive filter 7 is a Finite Impulse Response (FIR) filter, which implies that it can model the room impulse response up to a certain length of that response. Even if optimized and the adaptive filter 7 has converged to an optimal solution for a given stationary environment, there still remains a residual echo caused by the tails of the in this case S room impulse responses not covered by the finite length of the adaptive filter 7.

The echo canceller 1 further comprises an echo estimator 8 shown here as coupled between the spectral means 5 and the spectral subtracter 6 for estimating at least the tail part signal of echo to be suppressed. It is important to note that for the spectral subtraction, only an estimate I of the magnitude spectrum of the tail part of the echo is necessary, while the echo phase information may be omitted. So it is not necessary to have the full echo tail part information available for processing. This reduces the computational complexity and memory requirements of the echo canceller 1.

Although shown in FIG. 1 as a separate block 5 which is here subdivided into transformation means 5-1 and 5-2, these means may be thought to be included in the estimator 8 and the spectral subtractor 6 respectively.

The spectral subtractor 6 provides an echo tail part cancelled output signal U, which may depending on the application of the echo canceller 1 be subjected to an inverse spectral transformation by inverse spectral transformation means 9. Possible applications of the echo canceller 1 are found in hands-free communication devices, such as mobile telephones, or in a voice controlled system. For hands-free communication systems S is often 1, whereas for voice controlled systems S ranges from 2 (stereo systems) to 5 (surround-sound systems).

As fully detailed in FIG. 1 the adaptive filter 7 models the echo signals e such that after subtraction in a subtracter 10 a subtracter output signal r is spectrally transformed in second spectral transformation means 5-2 to reveal the transformed signal R. Spectrally subtracting or filtering the tail part echo signal I from the transformed signal R results in the echo tail part cancelled output signal U. In automatic speech recognition systems this output is the wanted output. In cases wherein a time domain output is wanted, phase information extracted by the second spectral transformation means 5-2 may be combined with the magnitude output signal U to reveal the wanted time domain output.

A maximum attenuation a which can be obtained be a perfect adaptive filter 7 having a length N (in samples) can be expressed as a function of the reverberation time T₆₀ of the room following:
A[dB]=60N/fₛT₆₀
where fₛ is the sampling frequency. However increasing N in the adaptive filter 7 for achieving a high echo attenuation tend to express non ideal effects, such as long convergence times, instabilities and slow tracking capabilities, especially if non-stationary and/or non white input signals are involved. However good tracking capabilities are important, because of temperature variations, environmental changes and movements in the room. In the echo canceller 1 the adaptive filter 7 may work in the time domain to cancel a pre-tail part of the echo, while the spectral subtracter 6 operates in the magnitude domain—that is exclusive the phase information—for cancelling the tail part of the echo. For tail part echo cancellation it is sufficient that only its magnitude is dealt with. This promotes a stable and robust echo processing, also in a non stationary environment.

At first a short survey will be given about a possible implementation of the spectral transformation known per se and performed by the transformation means 5-1 and 5-2. Reference is made to FIG. 2. Samples of an input time signal, such as the input signal x or the residual signal r are first converted from serial to parallel and then subjected to block processing. The input signal is processed in blocks of size B. Each new block is appended to the previous block resulting in a concatenated block size of 2B, which is then multiplied by a window function w(n) which satisfies the relation:

$${\sum }_{t = - ∞}^{∞} W ( n - 1 B ) = 1$$

The thus windowed block is then transformed by a Fast Fourier Transform (FFT) of size M≧2B. Suppose M equals 2B and knowing that the input signal is real valued, the magnitude of the B+1 independent FFT coefficients is computed. Apart from the magnitude, the squared magnitude or alternatively any other positive function of the magnitude can be used to represent the power in each frequency bin for the calculations of the FFT coefficients concerned. If a time domain output is required, the transform that is applied to the residual signal r must also provide the phase of the FFT coefficients for reconstruction after spectral subtraction. This is not necessary for the transform applied to the far end signals on signal input 4. If the echo canceller 1 is to be used for ASR, as already explained, a filter bank 11 can be used to reduce the frequency resolution and thereby reducing the implementation costs. The K output coefficients of the filter bank 11 are linear combinations of the B+1 input coefficients. If Xᵢ are the B+1 input coefficients to the filterbank 11 at an arbitrary time constant, then the K output coefficients Yₖ are computed according to:

$${Y}_{k} = {\sum }_{i = 0}^{B} {g}_{ki} {X}_{i} , 0 \leq k \leq k - 1 , \qquad ( 1 )$$

with arbitrary kernels gₖᵢ. In ASR, the kernels are usually chosen to be triangular with a frequency spacing that is linear on a so called MEL scale. (see L. R. Rabiner and B. H. Juang, Fundamentals of Speech Recognition, Englewood Cliffs N.Y., USA, Prentice-Hall, 1993). Typical choices for B and K are B=128 and K=15 at a sampling frequency of 8 KHz. If no filter bank is used, then K equals B+1. Every B input samples an output vector of size K is generated. The transformed far end signals on input 4 are—possibly delayed by a delay register 12, whose length is equal to the length of the adaptive filter 7—processed by the estimator 8 providing the spectral estimate I of the residual echo in R, in a way to be explained later. For the spectral filtering or subtraction in the spectral subtracter/filter 6 the following rule may be applied:
Uₖ=max [max(Rₖ−SIₖ, c₁Rₖ),c₂], 0≦k≦K−1,
where c₁ and c₂ are non negative constants, s is a positive subtraction factor, and Rₖ, Uₖ, and Iₖ are the elements of the vectors R, U, and I at an arbitrary instant in time. The constant c₁ can be used to limit the maximum attenuation introduced by spectral subtraction. A lower limit on the elements of U can be specified by the constant c₂.

Conversely if a time domain output signal is required, in the inverse transformation means 9 an Inverse FFT (IFFT) of size M=2B of the spectral vector U while being combined with the phase of r is computed, as shown in FIG. 6. The resulting block of size 2B is split into two parts of size B. The first part is added to the second part of the previous block and the second part is stored in order to be added to the first part of the next block. After being added the B signals are converted from parallel to serial to reveal the time domain output signal.

Now FIG. 3 shows a possible embodiment of the echo estimator 8. The S K-dimensional spectral coefficients from the transformation means 5-1 are fed to digital filter means DF here in the form of a possible parallel arrangement of S K-channel FIR filters, separately indicated FER₀. . . FIRₛ₋₁. Accumulation of respective filter outputs in summing device Σ gives the estimate of the echo I.

The structure of one of the filters DF, i.e. FIRₘ used in the estimator 8 is shown in FIG. 4. Therein the K-dimensional weight vectors which are indicated W_{m,l} with m=0, . . . ,S-1, and I=0, . . . ,L-1 are real valued and non negative. L is the filter length, that is the number of delay elements D, which is determined by the length up to which the S room impulse responses should be compensated for. If Nₕ denotes the length in samples of these responses, the length of the FIR filters in the estimator 8 is given by:
L=max{┌(Nₕ−N)/B┐0},
where N is the length of the adaptive filter 7, and B is the block length. The weight vectors W_{m,l} can either be computed in an initialization phase and thereafter kept constant, or can be adjusted adaptively. Adaptive adjustment is schematically shown in FIG. 1 by means of a dotted connection of an adder D to subtracter input vector signals I and R, whose adder output is coupled through a control unit C to the spectral estimator 8 for adjusting the mentioned weight vectors. This way the weight vectors W_{m,l} adaptively depend on the difference signal R-I. However fixed weights can be useful even in non stationary environments because (small) movements in a room effect the tail part echo from the so called diffuse sound field mainly by phase changes which are irrelevant for spectral subtraction, which does not operate in the phase domain. The fixed weights will be explained first, where after weight adaptation will be explained further.

Let hₘ(n) be an estimate of the length Nₕ of the room impulse response between the m-th far end channel and the microphone 3. This estimate can be obtained in an initialization phase where a special, preferably stationary and white test signal can be used to let a very long multi-channel adaptive filter 7 adapt to the room impulse responses. Alternatively, one single-channel adaptive filter can be used to sequentially estimate the impulse responses for each echo channel. Since in this phase no other processing takes place the necessary hardware can be dedicated completely to the adaptive filter, so that an increased complexity due to the very long filter becomes less problematic. After the initialization, the length of the adaptive filter 7 is decreased for further processing in order to reduce the complexity and to avoid the practical problems related to very long filters, mentioned earlier. If the transformation to the spectral domain by the spectral transformation means 5-1, 5-2 does not include a filter bank 11, then the weights W_{m l}, can be obtained by taking the magnitude of the 2B-point Discrete Fourier Transform (DFT) of the 1-th partition of length B of the last Nₕ-N samples of the estimated impulse response hₘ(n), according to:

$${W}_{m , 1 , k} = \vert {\sum }_{N = 0}^{B - 1} {h}_{m} ( n + N + 1 B ) exp ( - {j}_{π} nk / B ) \vert ,$$

M=0, . . . ,S−1;1=0, . . . ,L−1;k=0, . . . ,B,
where W_{m,l,k} is the k-th element of the vector W_{m,l}. If the filter bank 11 is used in the transformation to the spectral domain, the corresponding weights can be computed by applying the linear combination equation (1) above on the elements of the vector W, which leads to:

$${W}_{m , 1 , k} = {\sum }_{i = 0}^{B} {g}_{ki} {W}_{m .1 , i} ,$$

M=0, . . . ,S−1;1=0, . . . ,L−1;k=0, . . . ,B,
where g_{k,i} are again the filter bank kernels.

In order to avoid estimating the room impulse responses in an initialization phase, an adaptive algorithm for optimizing the weights during processing can be used. Another advantage is that the weights can then adapt to changes in the room which affect more than just the phases of the tail parts of the impulse responses. A possible implementation of the adaptive algorithm is for example the well known Least Mean Square (LMS) algorithm or the Normalized LMS. Since there are usually no fast changes in the magnitude spectrum of the tails of the room impulse responses, an update constant in the adaptive algorithm can be chosen very small resulting in a robust convergence behavior of the adaptive algorithm.

The implementation of FIG. 3 requires one K-channel FIR filter per far end channel. The estimator 8 can be simplified, as shown in FIG. 5, by exchanging the summation and the digital filtering operation and by replacing the S FIR filters by only one FIR filter. This results in a practically equivalent performance at greatly reduced implementation costs. As the tails of the impulse responses of a same room modelled by the S FIR filters mainly differ in their phases and not so much in their magnitudes, the error introduced by the one FIR filter is relatively small. This is being confirmed by recognition results. The digital filter means may comprise IIR or FIR filter implementations.

Whilst the above has been described with reference to essentially preferred embodiments and best possible modes it will be understood that these embodiments are by no means to be construed as limiting examples of the systems and method concerned, because various modifications, features and combination of features falling within the scope of the appended claims are now within reach of the person skilled in the art.

1. Echo canceller (1), comprising a signal input (4) for a far end signal, an audio input (A) for a distorted desired signal, an echo estimator (8) coupled to the signal input (4), and a spectral subtracter (6) coupled to the echo estimator (8) and the audio input (A), characterized in that the echo estimator (8) comprises digital filter means (DF) covering a time span of at least a part of the echo to be cancelled.

2. Echo canceller (1) according to claim 1, characterized in that the echo estimator (8) comprises a number (S) of digital filters, which number is equal to the number of echo paths in the echo canceller (1).

3. Echo canceller (1) according to claim 1, characterized in that the echo estimator (8) comprises one digital filter.

4. Echo canceller (1) according to claim 1, characterized in that the echo canceller (1) comprises an adaptive filter (7) coupled to the signal input (4) for estimating a pre-tail part of the echo.

5. Echo canceller (1) according to claim 1, characterized in that the echo estimator (8) is arranged as an adaptive echo estimator (8).

6. Echo canceller (1) according to the claim 5, characterized in that the echo canceller comprises a parallel arrangement of first (5-1) and second (5-2) spectral transformation means.

7. Echo canceller (1) according to claim 6, characterized in that the spectral transformation means (5, 5-1, 5-2) comprises at least one filter bank (11).

8. Echo canceller (1) according to claim 1, characterized in that the echo canceller (1) comprises inverse spectral transformation means (9).

9. System, in particular a communication system, for example a hands-free communication device, such as a mobile telephone, or a voice controlled system, which system is provided with an echo canceller (1), the echo canceller (1) comprising a signal input (4) for a far end signal, an audio input (A) for a distorted desired signal, an echo estimator (8) coupled to the signal input (4), and a spectral subtracter (6) coupled to the echo estimator (8) and the audio input (A), characterized in that the echo estimator (8) comprises digital filter means (DF) covering a time span of at least a part of the echo to be cancelled.

10. A method for cancelling an acoustic echo by spectral filtering, characterized in that at least a part of the echo is being estimated digitally and then spectrally filtered.
